(19) United States
(12) Patent Application Publication
(10) Pub. No.: US 2025/0315489 A1
(43) Pub. Date: Oct. 9, 2025

(54) Provenance Tracking Mechanisms for AI-assisted Content Generation

(71) Applicant: James Bryan Williams, Everett, WA (US)

(72) Inventor: James Bryan Williams, Everett, WA (US)

(21) Appl. No.: 19/171,266

(22) Filed: Apr. 6, 2025

Related U.S. Application Data
(60) Provisional application No. 63/575,302, filed on Apr. 5, 2024.

(51) Int. Cl. G06F 16/93; G06F 40/166

(52) U.S. Cl. CPC G06F 16/93; G06F 40/166

(57) ABSTRACT

This application concerns software-based improvements to computer systems. It relates to an apparatus, method, or program that allows computer systems to manage content generated with artificial intelligence by providing mechanisms for representing and reasoning about the provenance of said content. The application discloses several embodiments in different practical contexts, including change tracking for legal document generation, version control for source code, and real-time collaborative document editing.

### CROSS REFERENCE TO RELATED APPLICATIONS

This application claims the benefit to U.S. Patent Application Provisional Application Ser. No. 63/575,302 entitled “System and Method for Document Management Supporting Large Language Models through Provenance-based Versioning”, filed Apr. 5, 2024, the contents of which are hereby incorporated by reference in their entirety for any purpose.

### TECHNICAL FIELD OF THE INVENTION

This application pertains to the fields of software engineering and generative artificial intelligence (“GenAI”). It is concerned with improvements to computer systems. In particular, the application relates to an apparatus, method, or program that allows computer systems to manage content generated with artificial intelligence (“AI”) by providing mechanisms for representing and reasoning about the provenance of said content. The application discloses several embodiments in different practical contexts, including change tracking for legal document generation, version control for source code, and real-time collaborative document editing.

### BACKGROUND OF THE INVENTION

An increasing amount of content is being generated with the help of GenAI, including images, movies, and short stories (i.e., works). In many cases humans have difficulty determining whether a given work was produced by a human, an AI, or a human with the assistance of AI. Furthermore, GenAI uses content (e.g., digital books, digital images) for training purposes. The courts in various countries are grappling with the nuanced issues at the intersection of GenAI and intellectual property.

Data providence is a major theme in the current debates about GenAI (see, for example, the Data Providence Initiative, online at https://www.dataprovenance.org). Data provenance focuses on the history of data: it attempts to construct a record of the origins, custody, and transformations of data throughout its lifecycle. Ideally one would be able to determine where data came from, who created or modified it, what changes were made, when these changes occurred, and how it was processed.

Key activities in a data provenance program include: (1) origin tracking, which documents the source systems, files, databases, or instruments that initially created the data; (2) chain of custody, which records all entities that have accessed, modified, or transferred the data; (3) process documentation, which captures the specific transformations, calculations, or algorithms applied to the data; (4) temporal information aggregation, such as capturing timestamps for data creation and modification events, and; (5) quality assessment, which includes validation checks and data quality measures.

Data provenance is particularly important for scientific research (where reproducibility of results is essential) and regulatory compliance. It is a key part of data governance within organizations. It also plays a key role in trustworthy AI, as it can be used to provide transparency in data-driven decision making. Finally, it can be used to track sensitive or personal information for privacy purposes.

Organizations implement data provenance through metadata management, audit trails, and version control systems. However, the use of GenAI is relatively new and existing methods do not fully address the issues inherent in integrating GenAI with existing computer systems. As a result, it is difficult to provide data provenance for AI-generated or AI-assisted content. This results in major difficulties for traditional activities like document generation, where there are currently few (if any) mechanisms to determine which portions of a document were authored by AI and which were authored by a human. As a result, the utility of traditional computer systems and software is being challenged.

This disclosure discusses several embodiments that pertain to mechanisms for improving the functionality of computer systems using provenance mechanisms that are designed for GenAI. It illustrates these embodiments using several application domains: legal document generation, source code version control, and collaborative document editing. These are addressed in the following subsections.

### 1. Legal Document Generation

The past decade has seen an explosion of interest in legal applications based on AI. At the time of writing, there is a significant market for GenAI software tools that can help lawyers draft content. Large language models (“LLMs”) like ChatGPT are being used to draft legal documents. These models are trained on a large corpus of information, the composition of which is not (typically) made available to the public. In addition, retrieval-augmented generation (“RAG”) [Reference 1] allows AI tools to process documents from external databases (e.g., a law firm's digital file cabinet for a particular client).

There are several challenges facing lawyers who wish to use LLMs as a tool for drafting legal documents. First, LLMs are prone to hallucination (a.k.a., confabulation, delusion). A hallucination occurs when the LLM produces misleading information that is presented as fact [Reference 2]. This is not simply a theoretical concern. For instance, in Smith v. Farwell [Reference 3], the Supreme Court of Massachusetts sanctioned a lawyer for submitting legal memoranda that were plagued by citations to non-existent (i.e., fake) court cases. These citations were added when junior lawyers used an LLM to generate content.

Second, an LLM is trained on a corpus of data that may not be appropriate for the generation of legal documents that must conform to the laws/rules of a particular jurisdiction. For instance, the training data may include legal documents from other states (or countries) where terminology or legal rules differ in various ways from the target jurisdiction.

Third, LLMs typically change over time as new versions (e.g., ChatGPT 3.5 versus ChatGPT 4) are released to the public. LLMs can also be fine-tuned for specific tasks. In general, new versions of models involve new machine learning (“ML”) techniques, new training data, and various forms of human intervention. Output from two versions of the same LLM family are rarely the same.

Fourth, the output of an LLM depends heavily on the prompts that are used to elicit a response. The discipline of prompt engineering [Reference 4] has emerged as an art within the general field of LLM-based software development. Prompts give the context for a response and should be regarded as an important part of the interaction with an LLM. Evaluating an LLM's output sometimes requires knowing the prompt that was used to generate it.

Lawyers wishing to use LLMs within their legal practice require solutions to these (and other) problems. At present, the prevailing practice in the legal industry is to: (1) rely upon document templates (usually stored in Microsoft Word format) as the starting point for document creation; (2) share draft documents through email or document management systems (e.g., SharePoint, Dropbox, Google Drive); (3) use Microsoft Word's “track changes” feature to represent the changes made by each individual; (4) use in-document comments to communicate information between authors, and; (5) generate text via LLMs through a separate interface (e.g., web browser) and use a “copy and paste” mechanism to add it to the document. Some LLMs are also available as Microsoft Word plugins, but the context used to elicit a response from the LLM is not captured in the document.

There are numerous problems with the existing approach to document creation:
Documents can be left in an inconsistent state. For instance, two people can work on a document at the same time, making changes that cannot be reconciled automatically.
The “track changes” features will not provide information on whether a given change was made by an AI assistant.
Content suggested by an AI assistant is merged with the text so that it is difficult to discover which portions of the document are produced by an AI rather than a human author.
The context and background information used by AI assistants (e.g., ChatGPT) are not captured in the document.

Ideally, document management systems should provide solutions to these problems. First, more robust versioning is needed. Second, the system should maintain information about contributions made by AI assistants such as LLMs. That is, the system should show the provenance of content.

### 2. Source Code Versioning

The use of version control systems (e.g., Git, CVS) to manage source code is a fundamental practice in software engineering. Version control provides fine grained provenance for source code down to the level of individual characters. Developers can see when a particular line of code was added to a repository, by which user, and for what reason. They can view the difference between different files or branches using “diff” tools [Reference 5].

GenAI is becoming increasingly prevalent in software development. Tools such as Microsoft's CoPilot allow developers access to a huge body of knowledge that is encoded in LLMs. They can ask the AI assistant to generate code by supplying it with prompts.

One of the major problems, however, concerns intellectual property (“IP”). The major mechanisms to protect software are patent, trade secret, and copyright. Unfortunately, copyright regimes are designed to offer protection to human authors alone. As a result, source code that was generated by AI without sufficient oversight by a human author may not be protected.

To address this concern, version control systems should be augmented with a mechanism for adding AI-specific metadata to existing data provenance mechanisms. This would allow humans to analyze source code files to determine which portions were contributed by AI. Automated tools could also perform assessments of the portions of the codebase that are generated by AI, providing stakeholders with statistics on the portion of the codebase that can or cannot be protected by copyright.

### 3. Collaborative Document Editing

Tools like Google Docs, Office 364, and Etherpad allow users to create and edit documents collaboratively. These software applications support real-time editing, where the user interface shows a user X that another user Y is actively editing the same document. Typically, these tools use a variant of a changeset algorithm to track the changes to the document. The problem is that the tools are not currently configured to capture provenance information, particularly with respect to GenAI.

### SUMMARY OF THE INVENTION

This disclosure describes several embodiments of an apparatus (or system) and related methods for improving the ability of computer systems to manage content that is generated or modified by AI tools like LLMs. It provides mechanisms for content management (e.g., generation, modification, maintenance) that focus on data provenance in the context of GenAI. In most embodiments the system context involves multi-stakeholder collaboration: a variety of natural persons (i.e., humans) create and maintain collections of documents with the help of AI-based tools such as LLMs or image generators.

One of the goals is to allow a third-party (e.g., auditor, judge) to immediately determine: (1) the set of agents (humans or AI assistants) that authored a certain portion (e.g., phrase, sentence, paragraph, diagram) of the document; (2) a history of changes to the document—for instance, a full list of changes or a truncated history of the most significant contributions, and; (3) the information and tools that were relied upon in constructing a given portion of the document. This would include data sources and software artifacts (e.g., ML models). For content written by LLMs, the system would show the LLM's output, input prompt, version, and associated metadata (e.g., hyperlink to HuggingFace or GitHub). Since many AI systems are not individual ML models (e.g., a solitary neural network) but rather agent-based orchestrations of multiple models, useful data provenance mechanisms (such as those described in the present disclosure) should capture more than just the agent's output, but also information on its internal processing (e.g., chain-of-thought reasoning).

Different embodiments provide different means to convey this information. For instance, some embodiments provide the user with in-document visualizations of authorship like those provided by source-code differencing tools. Some embodiments provide additional facilities for document analysis:
Document validators, that evaluate a given document against a schema, template, or LLM trained for validation. For instance, a contract validator may provide an alert if a commercial contract lacks a common clause (e.g., assignment, merger).
Data validators, that check the accuracy of data within a document. For instance, an “address validator” might perform an address lookup to ensure that proper addresses are entered for the parties. “Case name validators” can lookup case citations in a legal database to make sure that they exist.
AI-authorship detectors, that attempt to detect portions of a document (or input text added to a document through copy/paste) that were authored by AI assistants such as LLMs. Grammarly's AI Detector is a good example of this type of facility.
Trust estimators, that assign trust levels to documents based on a variety of trust estimation techniques.
Risk estimators, that assign risk levels to portions of a document according to one or more risk models. For instance, portions of a document that were authored by LLM models known to have poor safety/fairness/reliability can be identified as riskier. These estimators can make use of public or private risk registers.
Graph-based visualizations, that show the various contributions of humans and AI assistants in the form of a graph. These approaches allow a user to visualize complex scenarios where a variety of mechanisms were used to create content (e.g., LLMs that validate the output of AI agents that have access to external databases).
Style-based attributors, that attempt to identify an author based on writing style. This type of tool can also analyze a document for variations in writing style in order to detect multiple authorships, inappropriately cited content, or poor coherence in writing style.
Plagiarism detectors, that attempt to detect passages that are copied from other works without attribution.

In some embodiments, these additional facilities take the form of modules or “plug ins” that can augment the basic functionality of the document management system.

In some embodiments, security functionality is provided to ensure that the provenance tracking information cannot be altered by users. For instance, provenance information returned from an LLM (alongside its generated content) can be cryptographically secured using a variety of mechanisms. This can eliminate the possibility of deletion or tampering.

FIG. 1 provides a simplified illustration of visualizing authorship in a passage of text (e.g., Microsoft Word's “track changes” feature). The system provides an overlay of the text that gives the main attribution for sentences and paragraphs. The first sentence (highlighted in orange) was authored by a natural person. The system shows the user and the date/time that the sentence was added. The second paragraph is a numbered list that was authored by ChatGPT. The system shows the date of creation, the version of ChatGPT, the user, and the prompt (input) that was used to generate the content.

This type of visualization can be extremely useful for legal documents with many authors, particularly junior associates or interns who may have less experience. The user can instantly see attribution, as well as the portions that were taken from an LLM. Detailed information allows auditors, information technology staff members, and courts to determine the provenance of each portion of text.

FIG. 2 provides a simple illustration of a “level of detail” mechanism that allows users to “zoom in” on passages and view progressively finer details on authorship. This type of visualization method addresses some of the shortcomings of “track changes” mechanisms in typical word processor software, which hammer the user with fine details. In this embodiment, each passage is highlighted with a color indicating the author. As the user increases the detail level, she can see small edits that cleaned up the text but did not really alter their fundamental content. These small changes are elided at higher levels of detail since they are “editorial changes” instead of substantive ones.

Level-of-detail visualization can be extremely useful for high-level summarization of authorship. A user can start at the highest level, where entire paragraphs or sections are colored by the author. Summary statistics can also be shown.

FIG. 3 provides a simple illustration of legal case validation. In this embodiment, the system checks each case citation against a set of legal databases. If it is unable to locate a case, it annotates the text with a warning. If it finds a case, it provides a hyperlink so the user can verify the citation.

In general, an LLM can be used for several tasks, including: (1) Summarization; (2) Text generation; (3) Translation; (4) Text simplification/condensation; (5) Suggestion; (6) Citation/Quotation; (7) Evaluation of accuracy; (8) Sentiment analysis; (9) Correction (e.g., grammar, spelling), and (10) Topic Identification. These (and other) tasks are supported by various embodiments in the present disclosure.

Finally, the use of text-based examples is illustrative and not intended to be limiting. Similar techniques for provenance can be applied to images, digital audio, 3D models, and other forms of content. Text is merely the most convenient form of content for the purposes of a patent application.

### BRIEF DESCRIPTION OF DRAWINGS

The various exemplary embodiments of the present disclosure, which will become more apparent as the description proceeds, are described in the following detailed description in conjunction with the accompanying drawings, in which:

FIG. 1 is an illustration of a user interface that shows the contributions of multiple authors to the same document.

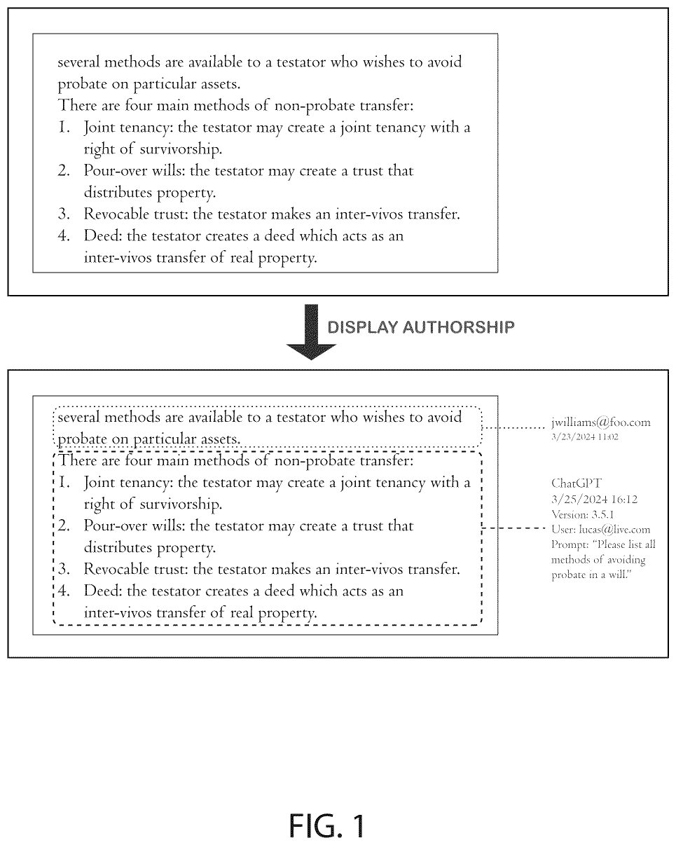

FIG. 2 is an illustration of a user interface that demonstrates a “level of detail” mechanism for showing the contributions of multiple authors to the same document.

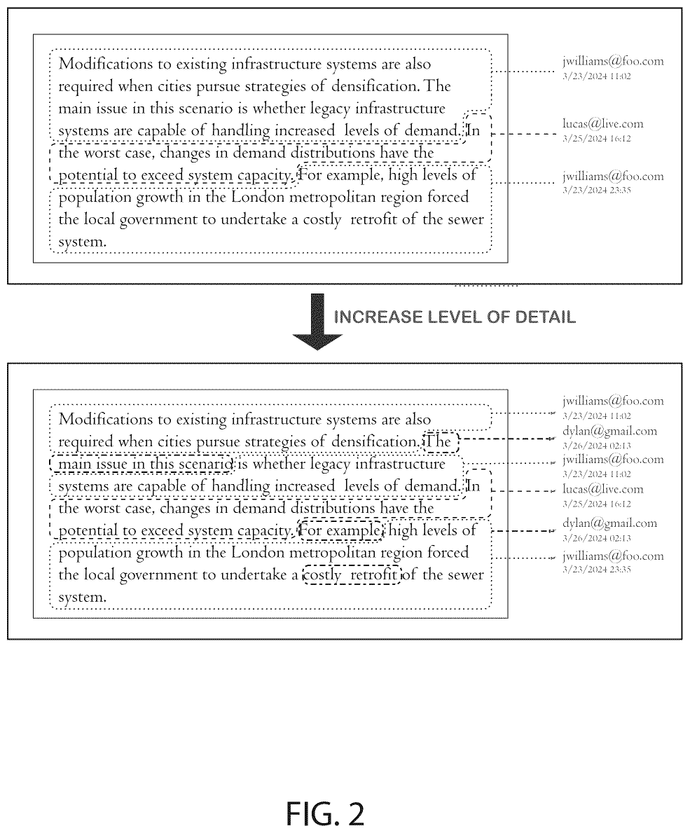

FIG. 3 is an illustration of a user interface that demonstrates a “case validation” mechanism for checking the accuracy of legal citations.

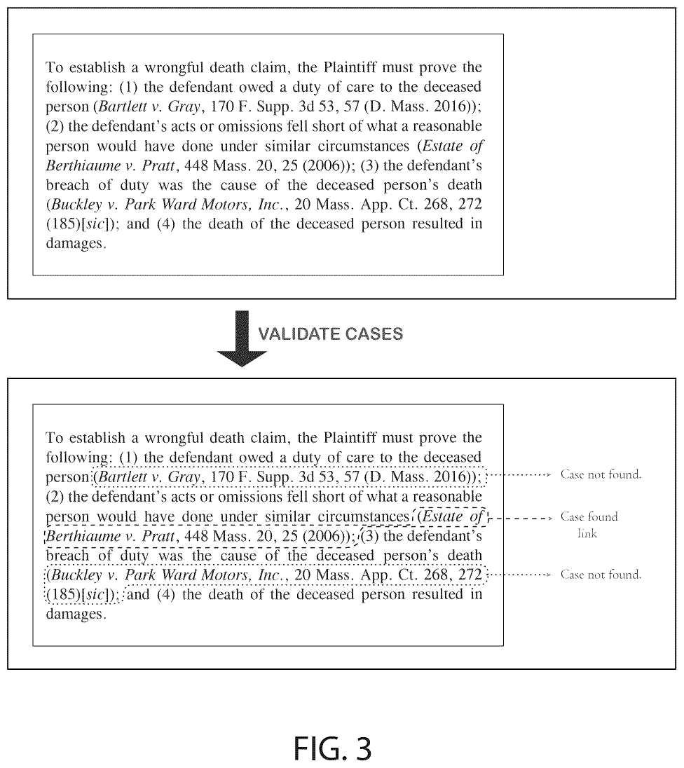

FIG. 4 shows the system context of the preferred embodiment, which relates to document generation and maintenance using word processors on a local workstation.

FIG. 5 shows selected data flows within the system context of the preferred embodiment.

FIG. 6 shows the system context of another embodiment, which relates to document generation and maintenance using online document platforms.

FIG. 7 shows a small dataflow for legal document creation.

FIG. 8 shows a small dataflow for legal document creation using LLMs.

FIG. 9 shows an event record for a “track changes” feature in a word processor.

FIG. 10 shows an event record for data provenance information.

FIG. 11 shows an event record for data provenance information that supports RAG.

FIG. 12 shows an event record for data provenance information that supports RAG and more complicated orchestration.

FIG. 13 shows a system architecture for an embodiment.

FIG. 14 shows a basic dataflow for the most basic modules in an embodiment, where a data provenance module is used to interface with AI systems.

FIG. 15 shows a basic dataflow for the most basic modules in an embodiment, where a data provenance module is used to interface with AI systems and directly updates a document structure.

FIG. 16 shows a more sophisticated dataflow for the most basic modules in an embodiment, where an AI assistant module is used to interface with AI systems.

### DETAILED DESCRIPTION

Since this disclosure covers more than one application domain, the detailed description is partitioned into three subsections: (1) legal document generation; (2) version control systems, and; (3) collaborative, real-time document editing. As noted above, the focus on text content (e.g., legal documents) in this disclosure is illustrative and not intended to be limiting. Data provenance techniques of the sort discussed in this disclosure can be applied to other forms of content, including audio, video, images, and 3D models. It would be impractical to cover all these types of media in a single application.

### 1. Legal Document Generation

In this (preferred) embodiment of the present disclosure, the focus is on providing provenance information for document generation and management across the entire document lifecycle. The main use case involves drafting documents using Microsoft Word, which is the main word processing tool used in the legal industry. In this illustrative scenario, lawyers use Microsoft Word alongside AI-based assistants (e.g., third party LLMs accessed through a variety of means, such as plugins or direct visits to websites). The secondary use case involves drafting documents on an online platform such as Google Docs, Office 365, or Etherpad. In this case, the user uses a thin client while the main software applications reside on remote servers. In both cases similar provenance mechanisms can be used.

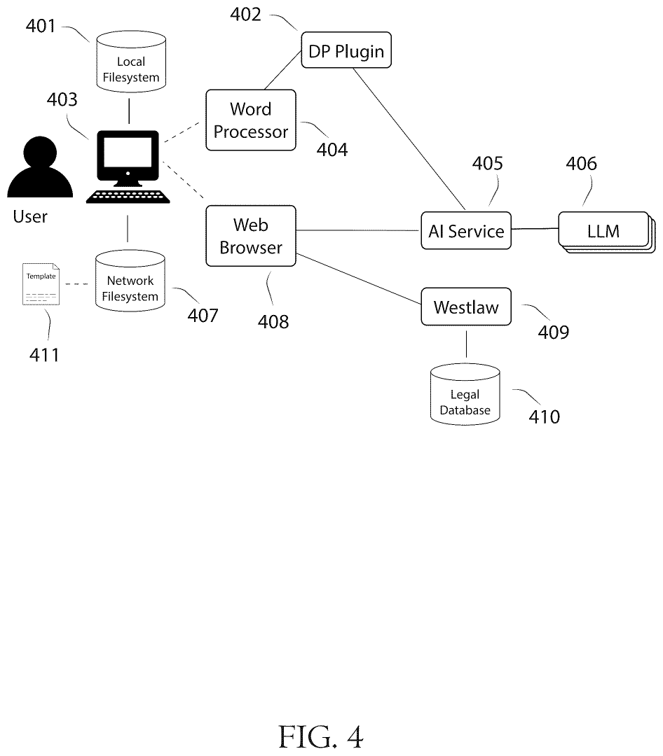

FIG. 4 shows the system context of the preferred embodiment. A user operates a local workstation 403 (e.g., personal computer, tablet). The workstation has a web browser 408, a word processing program (e.g., Microsoft Word) 404, and connections to a local filesystem on the workstation 401 and a network filesystem 407. The network filesystem contains templates 411 for the word processor as well as client files and a host of other documents. A data provenance plugin (“DP Plugin”) provides the provenance functionality and acts as a mediator between the word processing program and an AI Service 405. In some embodiments it may also maintain a local data store that maintains data provenance information for each document. The AI Service 405 may be an endpoint to a commercial provider like OpenAI or Anthropic, or it may be a local plugin that uses either a local or remote model. FIG. 4 is illustrative, and nothing in the diagram is intended to limit the possible methods of accessing the AI endpoint or deploying a plugin/module on the workstation. The AI Service 405 typically is a front end for a highly orchestrated and complex AI system that uses multiple models such as LLMs 406. The user can also access other AI services through a web browser, bypassing the plugin. The user may also access Westlaw 409 and other legal databases 410.

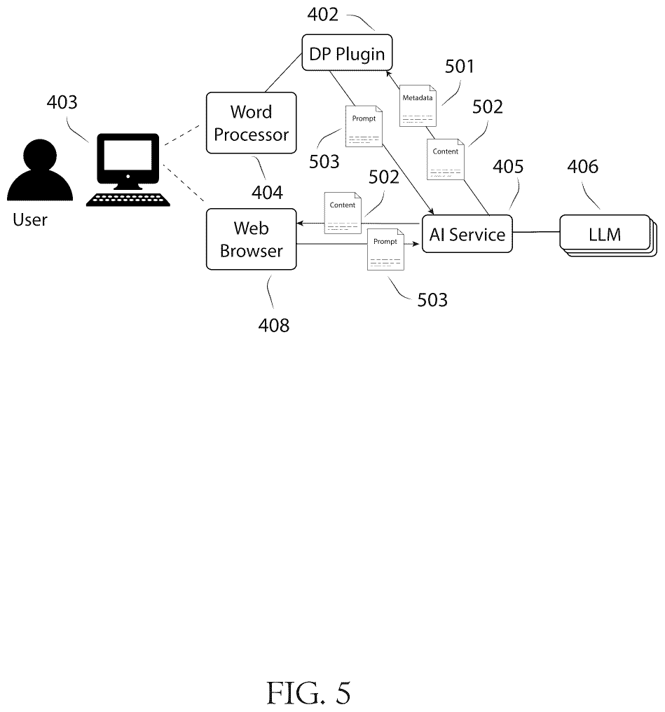

FIG. 5 shows a subset of the data flows within the system context. The user submits a prompt 503 to the DP Plugin 402 (or alternatively to another module that subsequently calls the DP Plugin). The DP Plugin sends the prompt 503 to the AI Service 405. The AI Service 405 responds with content 502 and metadata 501. The DP Plugin will assemble provenance records for the content by using the metadata along with other information (e.g., timestamp, the prompt 503). The user can also use the web browser 408 to send the prompt 503 to the AI Service 405. In this case any metadata is not captured and hence it is not represented in the return data flow to the web browser 408. The user merely takes the content 502 and copies portions into documents. FIG. 5, again, is merely illustrative and not intended as limiting. There are, for example, many alternative ways to use an LLM, including running an LLM on a local server or on the workstation itself. There are also many useful AI models that can be used by the AI Service 405, not all of which are LLMs.

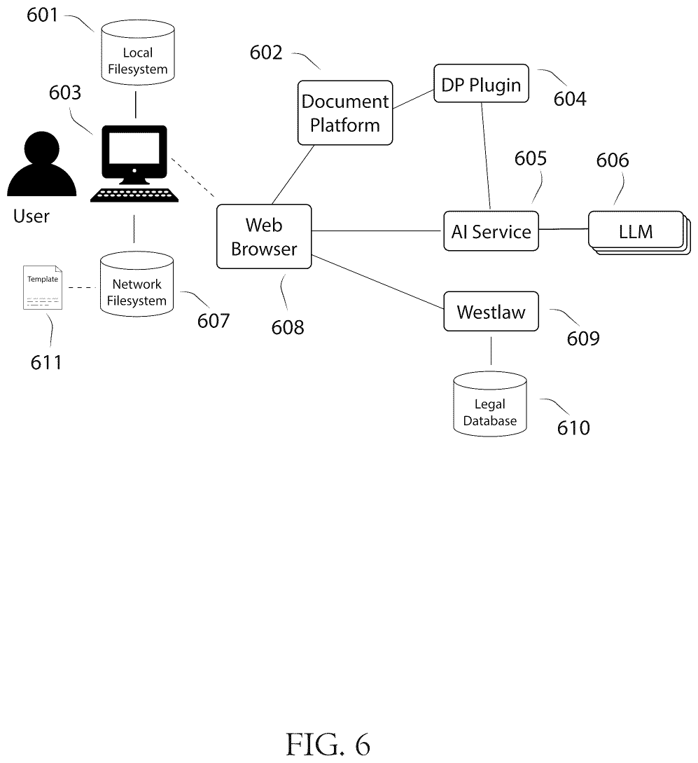

FIG. 6 shows the system context for the secondary use case. In this embodiment, there is no local word processor. Instead, the user uses the web browser 608 on their workstation 603 to use an online document platform 602 (e.g., Google Docs, Office 365). A DP Plugin 604 on the online document platform 602 performs the same function as in the main use case. The local filesystem 601, network filesystem 607, Westlaw 609, legal database 610, AI Service 605, and LLM 606 are the same as in the main use case. As before, the diagram is intended as illustrative and is not intended to be limiting.

There are many other architectures that can be used. For instance, there could be multiple users, multiple types of client devices, and multiple AI Services. An AI Service could use other types of AI models apart from LLMs. The architecture of the system could consist of a single machine, a network of machines, a client/server arrangement where the “server” is actually a large cloud-based software system, or a peer-to-peer distributed system where there is no central server and all of the elements (including the AI service) are always in flux.

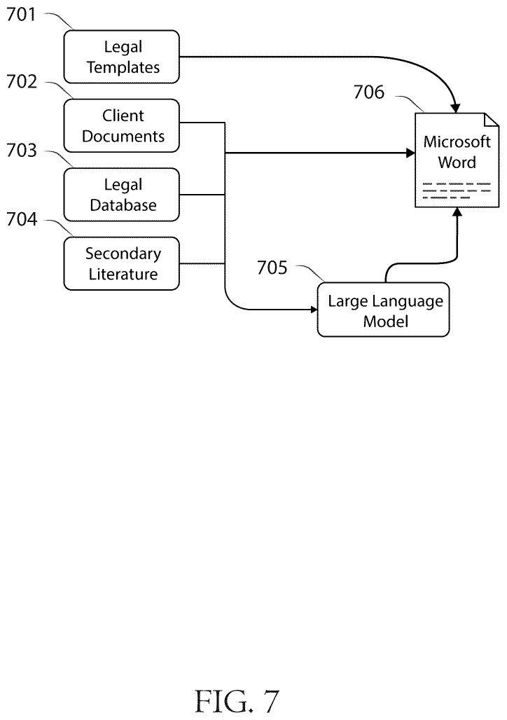

FIG. 7 illustrates the (naïve) data flow of legal document construction using LLMs. The legal document 706 is usually stored in Microsoft Word format. It is almost always constructed from a legal document template 701. The authors of the legal document 706 draw from several sources, including client documents 702, legal databases 703 (e.g., LexisNexis, Westlaw), and secondary literature (e.g., legal encyclopedias, treatises) 704. Authors may also input information from these sources into an LLM 5, the output of which is added to the legal document 706. Typically, this occurs when an author asks questions through a web-based interface (e.g., ChatGPT), but in some cases an LLM may be available on the client's local computer or integrated into the document editing application itself.

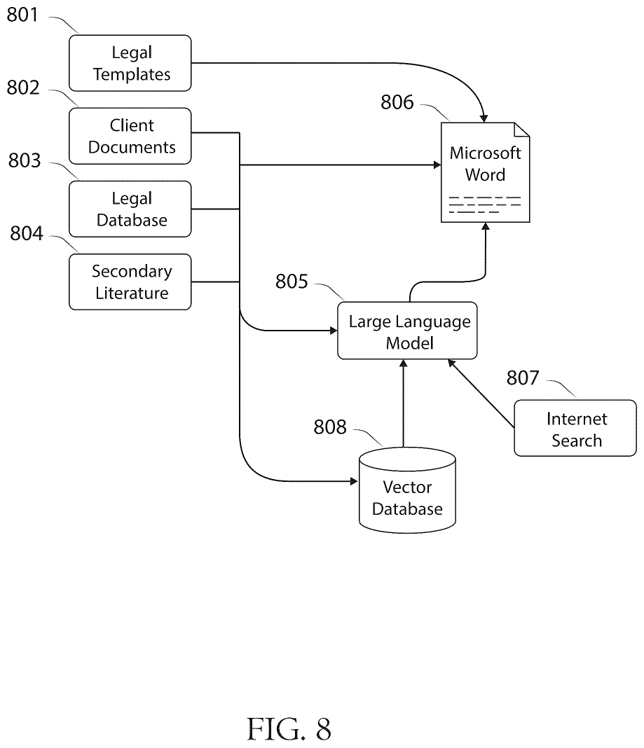

FIG. 8 illustrates the process of legal document 806 construction using an LLM 805 in combination with retrieval-augmented generation (“RAG”). RAG is used to provide LLMs with information from additional, external data sources (e.g., relational databases, unstructured document repositories). Information of this sort can be embedded into a “vector database” 808 for retrieval, or it can be provided to the LLM using an agent-based software component. For example, the LLM may have an agent-based component that allows it to search the internet 807. RAG greatly complicates the workflow for legal document construction as there may be a great amount of data involved, and the user is not necessarily in control of what is passed to the LLM. (The client documents 802, legal database 803, and secondary literature 804 are the same as in FIG. 7).

The present disclosure is aimed at improving these existing approaches to document construction using LLMs. In general, some embodiments of the present disclosure provide document history that includes provenance information for content. This provenance information records various metadata elements, including the agent (e.g., human, LLM) responsible for a change, a timestamp for the change, the method of applying the change, and the content that was added or removed. Changes made by LLMs will also contain metadata specific to LLMs, such as the prompt (i.e., the text provided to the LLM), the LLM name and version (e.g., ChatGPT 3.5.1), known risks, explanations of how the response was generated (e.g., through explainable AI algorithms) or any other information that is required to understand how the LLM generated the response from the prompt. This information allows a user to understand the history of the document in detail. It goes beyond what is provided in a “track changes” feature.

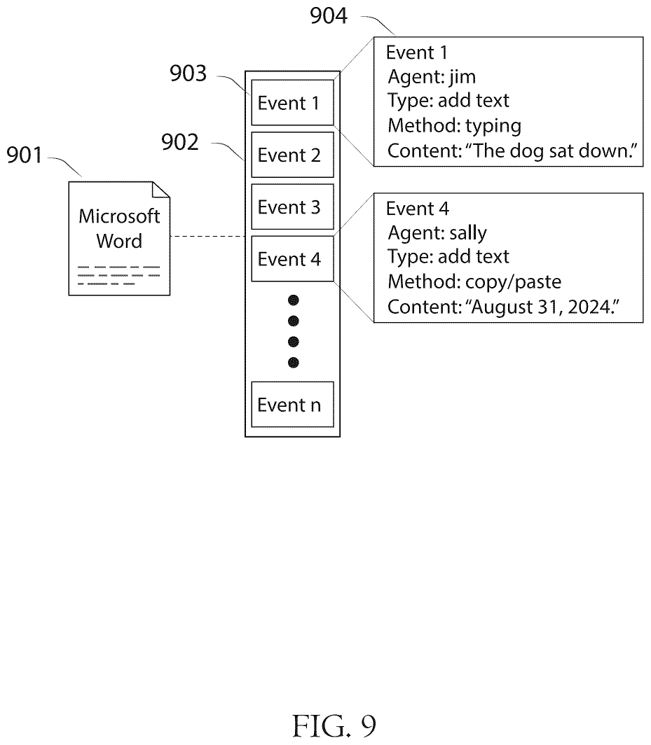

FIG. 9 illustrates an “event history” data structure for one embodiment of the present disclosure. The legal document 901 is again stored in Microsoft Word format. The event history data structure 902 contains a sequence of events (e.g., ordered in time). Each event 903 contains a set of metadata elements 904 that describes the important properties of the event. For instance, the metadata elements 904 may include an agent identifier (e.g., email address, username), an event type (e.g., addition of text), a timestamp, a location in the document (e.g., offset), a method (e.g., cut-and-paste), and the relevant content (e.g., the text that was added or removed). In some embodiments, these events may be granular enough to capture individual character modifications (e.g., deleting a single comma). In other embodiments, they may capture changes at the level of entire sentences. It should be noted that not every metadata element is shown in the diagram (e.g., timestamps are omitted), and the diagram is not intended to be exhaustive of the full range of metadata elements. Nor is the use of a sequence to describe the event history data structure 902 intended as limiting. A variety of alternative data structures could be used.

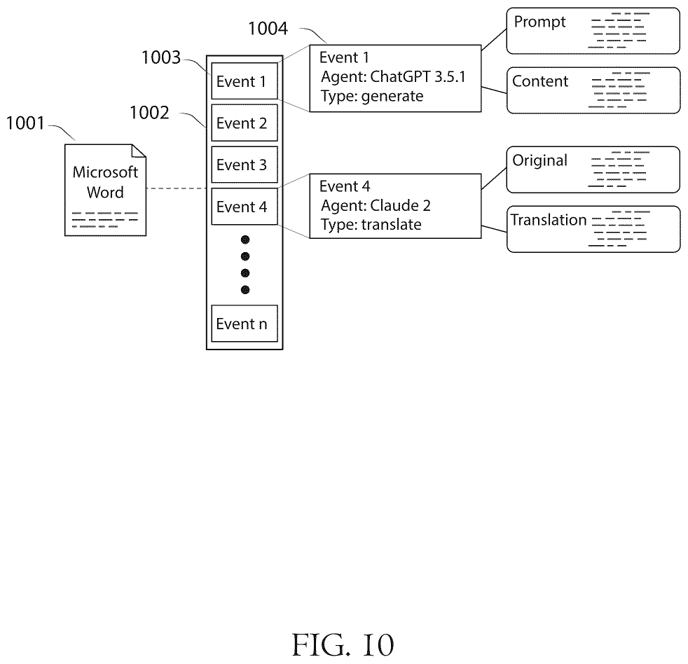

FIG. 10 also illustrates an “event history” data structure for one embodiment of the present disclosure. Again, the focus is on a document 1001. The elements of FIG. 10 are similar to those in FIG. 9, but in FIG. 10 two of the events 1003 are generated by LLM agents instead of people. Event 1 was created by using an LLM to generate text based on a user-supplied prompt. The metadata elements 10 include the full text of the prompt and the full text of the LLM's response. Similarly, event 4 was created by using a different LLM (Claude 2) to translate a paragraph of the document from one language to another. The original text and the translated text are stored in the metadata elements 1004. FIG. 10 is not intended as limiting the full range of metadata elements, nor is the use of a sequence for the event history data structure 1002 intended as limiting.

The previous figures show very simple uses of LLMs to generate content for documents. More sophisticated approaches are used in practice, including RAG. Multiple LLMs may be chained together to collaborate on tasks. For instance, one LLM may perform quality checks on the output of another LLM. One LLM may perform query rewriting while another ensures that the most important elements from a vector database are listed first in the prompt. Techniques such as “chain of thought” are commonly used to improve the quality of LLM responses. Some embodiments of the present disclosure deal with these scenarios by tracking additional data in the event history.

It should also be noted that all embodiments of this disclosure provide a means by which the user can identify, for a given portion (e.g., character, word, sentence, or paragraph) of the document the set of events that were involved in constructing that portion of the document. For instance, if a paragraph was generated by an LLM, there is a means of identifying the event that records the LLM's activities (i.e., in the event metadata). In some embodiments there is synchronicity between the event history and document: (1) the event history can be examined from the perspective of document elements, and (2) the document can be reconstructed from an initial state by applying the events in order.

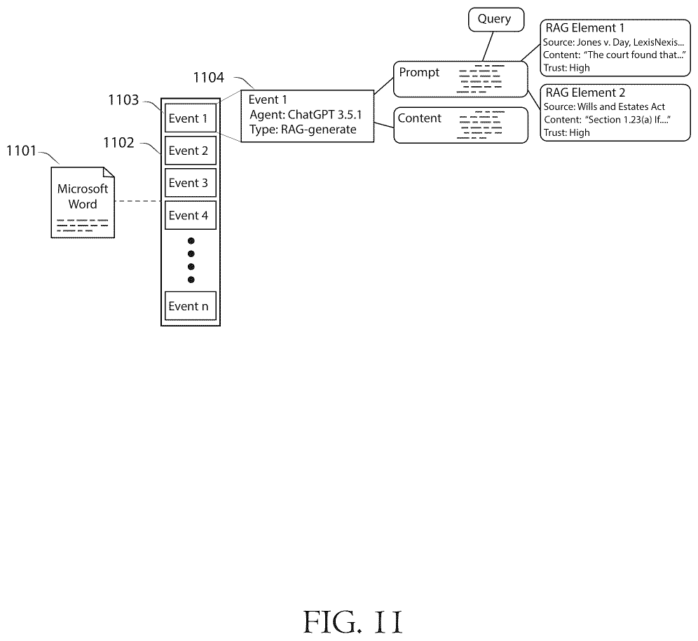

FIG. 11 illustrates an “event history” data structure for one embodiment of the present disclosure. Again, the focus is on editing a document 1101 with the use of an LLM. The elements of FIG. 11 are similar to those in FIG. 9 and FIG. 10, but the only event shown in detail is created by a basic application of RAG to a query. In this case, the metadata elements 1104 are more extensive. This simple application of RAG works by: (1) taking a user query (prompt), (2) embedding it into a high-dimensional space as a vector, and (3) searching a vector database for the most relevant documents (chunks) pertaining to the query vector. The most relevant documents are then used as input to an LLM by attaching them to the LLM prompt. The metadata elements 1104 in FIG. 11 contain the RAG query and metadata for two documents (RAG Element 1 and RAG Element 2) that were obtained from the vector database. The first of these documents is an excerpt from Jones v. Day, a reported law case found in the LexisNexis legal database. The second of these documents is an excerpt from a statute. In this embodiment, each of these documents is given a trust level to indicate whether the source is trusted or not. Many other attributes could be included, such as the paragraph, clause, section (etc.) or other location information for the documents. (The event history data structure 1102 and events 1103 are similar to those of FIG. 10). Again, FIG. 11 is not intended as limiting the full range of metadata elements.

Methods for estimating the trustworthiness of documents are extremely useful for several application domains, including law and health care. Many interpretations of provenance incorporate some notion of trust in data sources or reliability of information. In some embodiments of the present disclosure, trust levels can be assigned to information (e.g., documents, databases, witness testimony obtained from depositions). These trust levels can be traced through the event history so that inferences can be made about the trustworthiness of portions of the document.

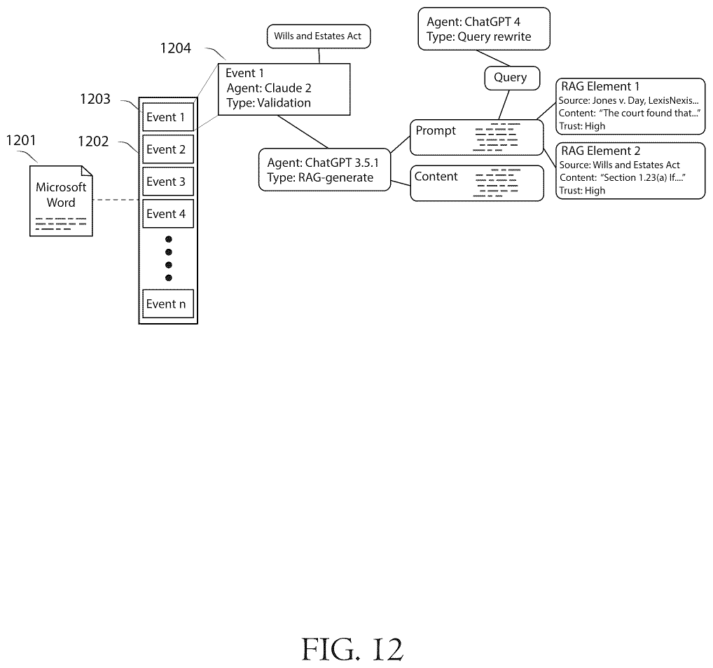

FIG. 12 illustrates an “event history” data structure for one embodiment of the present disclosure. Again, the focus is on editing a document 1201. Elements (the event history data structure 1202, events 1203, and event metadata 1204) are similar to those in FIG. 11, but the use of RAG is more sophisticated. In this illustration, two changes are made to the basic structure in FIG. 11: (1) query rewriting via a second LLM (ChatGPT 4) is used to alter the query to the vector database, and (2) the output from ChatGPT 3.5.1 is validated by using a third LLM (Claude 2) alongside a full copy of the statute. This example shows how the event metadata 1204 can take the form of a tree data structure. The use of additional data structures for LLM-based natural language processing is common and should be considered to be supported by various embodiments.

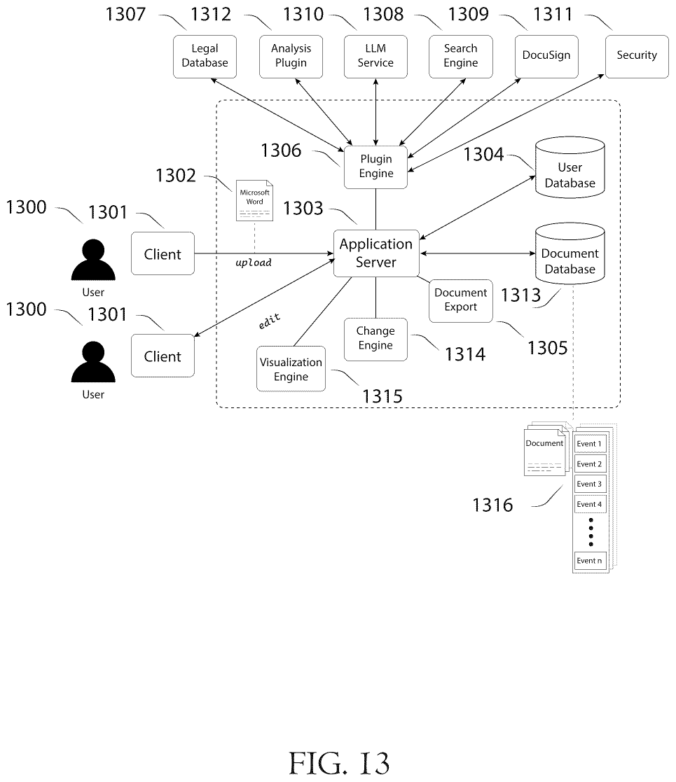

FIG. 13 illustrates software architecture for one embodiment of the present disclosure—an online document editing program with data provenance support for AI assistants. A user 1300 (natural person) interacts with the system through her local client 1301 computing device (e.g., tablets, personal computers). A user 1300 may upload a document 22 (e.g., template, draft document) to the system, or she may create and edit documents directly by using services provided by the system. In some embodiments, multiple users 1300 can collaborate in real-time on the same document (e.g., as in Google Docs or Office 365). Changes made in collaborative document editing are tracked by the system.

The core of the software architecture in FIG. 13 is an application server 1303 that provides the core functionality for the system. This includes managing user information (password, demographic information) that is stored in a user database 1304. Of course, the diagram is intended as illustrative and should not be considered limiting. The application server 1303 is likely to be a distributed software system with multiple servers operating in multiple data centers, and with additional features such as distributed queues, load balancers, and local caches. The diagram shows the high-level architecture of such a system. The application server 1303 is not strictly intended to be a monolith, and could be implemented in many ways, including the use of serverless technologies such as Amazon Web Services (“AWS”) Lambda functions. Similarly, the user database 1304 is illustrative, and it could be instantiated in many ways including the use of distributed databases (e.g., MongoDB).

The document export component 1305 of the architecture provides facilities for importing and exporting documents to/from the system. For instance, users may wish to upload and download documents in common file formats (e.g., PDF, Microsoft Word). Documents may be exported in a variety of formats, including formats that preserve full change histories and provenance. Another role for the document export component 1305 is a “take out” feature that allows a user to export their entire document library so that it can be migrated to a competing system. Documents are stored in the document database 1313.

The plugin engine 1306 allows third-party developers to develop plugins for the system. For example, a legal database plugin 1307 allows users of a system to access legal databases like LexisNexis or Westlaw. The advantage of this type of plugin is that the system can store metadata about searches and content delivery automatically (e.g., automatically storing the search terms, search results for a query, or the paragraph or case citation for content copied from the legal database). This information forms part of the provenance of a document. A search engine plugin 1308 provides similar functionality for search engines, storing key metadata for documents retrieved from the internet. A DocuSign plugin 1309 allows documents to be exported to DocuSign for digital signatures. An LLM Service plugin 1310 interfaces with common LLM services (e.g., ChatGPT), allowing the user to interact with LLM-based software through the system. As with other plugins, the system will save important metadata from these interactions (e.g., prompts) as part of the provenance of a document. A security plugin 1311 provides security functionality for the system, particularly safeguards against tampering with provenance information and non-repudiation. A set of analysis plugins 1312 extend the functionality of the system by allowing the user to run various analyses on content (e.g., checking to see if the LLM generated spurious court cases, or performing risk or trust evaluation The set of plugins shown in the diagram is not intended as limiting, and other plugins are available (e.g., Zotero or Mendeley plugins for retrieving information from academic research papers). Nor is the plugin engine 1306 intended as a single component, as it could be presented in different forms in various embodiments.

The heart of the software architecture shown in FIG. 13 is the change engine 1314, which is responsible for creating change histories for each document. This is the key component that tracks the provenance of information for each document. It will manage document data structures that are stored in the document database 1313. Each document has an event history 1316 that records the changes made, the data sources used (etc.) as described in the previous pages of this disclosure. The change engine 1314 is responsible for creating and managing these event records, including: (1) creating events upon a change to a document; (2) capturing metadata from interactions with LLMs or other tools; (3) merging change histories when documents are merged; (4) pruning events from a change history when content is deleted from a document and the relevant events should be similarly deleted. As with other components, the change engine 1314 is not necessarily a single component, but rather the diagram is illustrative of functional roles and is not intended as limiting. The change engine 1314 could be implemented as a micro-service or in a serverless fashion.

The document database 1313 stores documents. It provides users with persistent storage that maintains a document collection over time. It may support a document hierarchy (e.g., file tree) that facilitates document management. The document database 1313 is not intended to represent a single data store, but rather a functional role that may be played by a more complicated system consisting of separate back-end servers in combination with distributed data stores.

The visualization engine 1315 provides visualizations of a document's change history. For instance, in some embodiments it may support some of the visualizations described earlier in this disclosure (e.g., color coding sentences by author). In general, it uses a document's change history. Note that this element of the architecture is not intended to be limited by the diagram. It could, for instance, be deployed as a component in the client's web browser as an alternative to being a module residing in the application server.

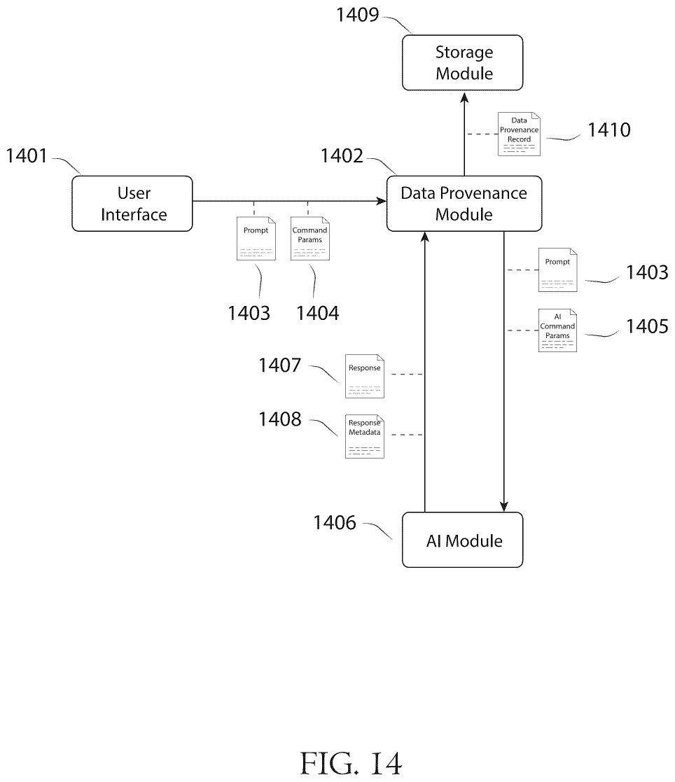

FIG. 14 provides a highly abstract view of the main components of one of the embodiments of the current disclosure. A user (not shown) enters a prompt 1403 into a user interface 1401 along with a variety of user and system specified command parameters 1404. The term “user interface” is intended to be illustrative and not limiting, since the prompt could be generated and sent through a command line on an operating system, an API endpoint, or another AI agent. Similarly, the term “prompt” is not intended to be limiting: instead of text, a prompt could contain a combination of different forms of data, including text, audio, or video. The command parameters 1404 can contain a variety of parameters that can influence the AI assistant (e.g., the “temperature” parameter common to many LLMs) or other non-AI aspects.

The prompt 1403 and the command parameters 1404 are sent by the user interface 1401 to a data provenance module 1402 that is responsible for assembling data provenance records 1410. The data provenance module 1402 sends the prompt 1403 and a set of AI command parameters 1405 to an AI module 1406 that serves as the gateway to an AI system that will be used to generate content. The AI command parameters 1405 may contain some of the information in the command parameters 1404, but they may contain additional parameters as well. In general, this arrangement is not intended to be limiting. The data provenance module 1402 could take the form of either a local or remote service, and it could access multiple AI modules 1406 according to various criteria. The internals of the AI module are not shown, since these systems range in complexity from local models installed on a laptop or desktop computer to major software services such as ChatGPT or Claude 2. For simplicity, FIG. 14 shows a single entry point into the AI service.

The AI module 1406 takes the prompt 1403 and AI command parameters 1405 and uses them to generate a response 1407 and a set of response metadata 1408. The response contains the content that answers the user's prompt 1403. The response metadata 1408 contains additional information about the response. In general, the contents of the response metadata 1408 will depend on the AI module and the AI tools used within it. The response metadata 1408 may include the name and version of the LLMs that was used to answer the query, a call/activation stack for multiple stages of an orchestration episode (e.g., multiple LLMs and AI tools that are used in concert to create a response), a session ID, a description of the training data relied upon to build the AI tools, trustworthiness or risk ratings for the LLMs used to generate the response, model weights, statistical summaries of key metrics, and the results of any analyses by “explainable AI” tools. There are many options for data elements, and the current diagram and description are not intended as limiting.

The AI module 1406 returns the response 1407 and response metadata 1408 to the data provenance module 1402. The data provenance module 1402 generates a data provenance record 1410 from this information, as well as other information (e.g., the current time, the user identifier of the user, the prompt 1403, and the command parameters 1404). The data provenance record 1410 can take a variety of forms depending on the application. It can be saved to persistent storage by using a storage module 1409. Finally, the response can be returned to the user interface and, by extension, the user (not shown for simplicity). The user can then use the content.

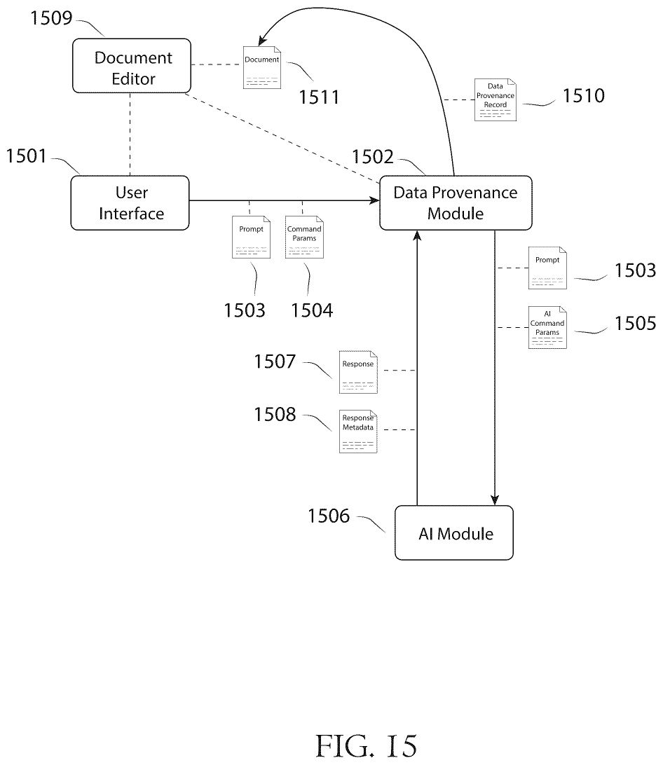

FIG. 15 adapts the basic workflow of FIG. 14 so that the data provenance information is stored in the data structure of a document itself rather than in a separate data store. A document editor 1509 (e.g., Microsoft Word, Google Docs, Office 365) is used by a user to construct or edit a document 1511. Again, the user uses the user interface 1501 to send a prompt 1503 and command parameters 1504 to a data provenance module 1502. The same workflow with the AI module 1506 is performed as in FIG. 14 (with the AI command parameters 1505, response 1507, and response metadata 1508). The difference this time is that after the data provenance module 1502 assembles the data provenance record 1510, it does not save the latter to a persistent data store. Rather, it integrates the data provenance record 1510 into the internal data structures of the document 1511. (For example, it may update the document's “track changes” data structure). In some embodiments it may insert the response 1507 into the document 1511, while in other embodiments the task of inserting the response into the document 1511 may be the job of the document editor 1509. In practice, a wide variety of data structures are used to represent documents (e.g., XML, JSON), and a wide variety of internal layouts are used to represent content and version tracking information. Once the document is updated, the document editor can refresh its view, and the user will see the changes. This is, of course, not intended as limiting, since it is not a requirement of this embodiment that the document editor use a particular architecture (e.g., model-view-controller). A wide variety of options are available for architecting a practical solution, such as incorporating the data provenance controller 1502 as an internal feature of the document editor 1509, or having it as a microservice in a distributed, cloud-based document editing system.

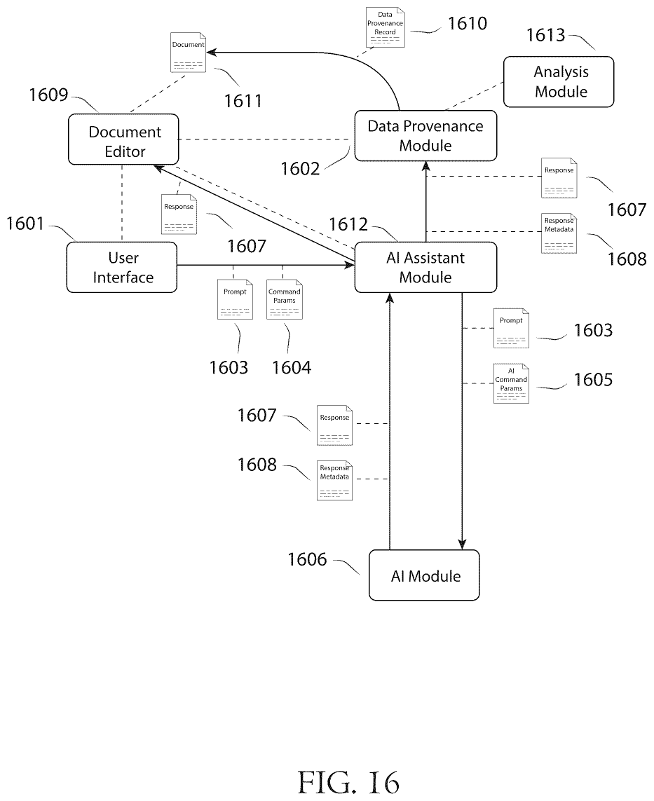

FIG. 16 shows another embodiment in which the data provenance module 1602 does not directly call the AI module 1606. Rather, an AI assistant module 1612 performs that task. When the AI module returns the response 1607 and response metadata 1608 to the AI assistant module 1612, that information is sent by the AI assistant module 1612 to the data provenance module 1602 (e.g., by a publish-subscribe mechanism). The data provenance module 1602 can invoke one or more analysis modules 1613 to perform analysis of the response 1607 and response metadata 1608. (For instance, a “legal case validation” analysis module may validate that legal cases exist by checking external databases; a “trust assessment” analysis module may analyze trust levels according to the version of Al tools used to generate the response; a “model likelihood” analysis module could determine the likelihood that the response was generated by a particular set of LLMs). The data provenance module 1602 updates the document 1611 with the data provenance record 1610 while the AI assistant module 1612 returns the response to the document editor 1609. Not shown in this Figure (but shown earlier) is a security module that provides a variety of security functions for data provenance information.

As above, this diagram is merely illustrative and is not intended to be limiting. A wide variety of options are available for architecting such a system, and the types of communications channels and other major details are elided for just that reason.

### 2. Source Code Version Control

Another embodiment relates to source code version control systems (“VCS”) such as Git and CVS. These systems allow developers to work on a local copy of a repository, while a global copy is either maintained on a centralized server or through a distributed system (e.g., peer-to-peer system). Developers can use AI tools like CoPilot to write portions of the source code. Many systems have change-tracking features that store metadata about changes to the code. Metadata related to changes is submitted to the global repository when a developer “commits” code. If there are inconsistencies between the global version of a file and a local version, the developer must resolve the inconstancy—often using a “merge.”

VCS systems can use many of the same techniques outlined above to integrate data provenance mechanisms. A data provenance module can capture key metadata regarding content generated by AI tools. This metadata can be stored in the local change tracking data stores and sent along with the source code to the global repository. The tracking of changes to source code files is made more complex by conflict resolution (e.g., merging). Furthermore, many VCS systems do not store multiple versions of a file, but rather the “deltas” (i.e., the changes from one version to another).

Many of the principles discussed in the previous section apply to VCS systems. For example, one should store metadata that includes the location of edits, the name and version of AI tools that were used to generate content, etc. Some AI tools track the data sources that were used in generating a response, and this information can be added to the metadata for help in debugging and for attribution. Integrating this metadata into the internal data store of a VCS is not trivial.

The presence of data provenance metadata in a VCS system is an enabler for a variety of tasks, including automated analysis of codebases to determine which portions are not protected by copyright (as discussed in previous pages). Since the architecture and design of VCS systems is a large, specialized topic, no further discussion takes place in this document.

### 3. Real-Time Collaborative Document Editing

Finally, data provenance techniques can be applied to content generation systems that offer real-time, collaborative editing. Some of these systems are based on peer-to-peer architecture, but some (e.g., Google Docs, Etherpad) use centralized architecture. One of the main features enabling real-time collaborative document editing is the use of changesets to track changes to documents. Data provenance information can be added to changesets as metadata, it can be stored in a separate data store that maps a changeset to a data provenance record. Since the architecture and design of these systems is a large, specialized topic, no further discussion takes place in this document.

### REFERENCES

1. Yunfan Gao et al., Retrieval-Augmented Generation for Large Language Models: A Survey, (2023), http://arxiv.org/abs/2312.10997.

2. Ziwei Ji et al. “Survey of Hallucination in Natural Language Generation,” ACM Computing Surveys. 55 (12) pp.1-38, 2022.

3. Smith v. Farwell, Commonwealth of Massachusetts, Superior Court Civil Action No. 2282CV01197, decided Feb. 12, 2024. See also Kruse v. Karlen, Missouri Court of Appeals, Eastern District, No. ED111172, filed Feb. 13, 2024.

4. Oliver Campesato, Transformer, BERT, and GPT3: Including ChatGPT and Prompt Engineering, Mercury Learning and Information, 2023.

5. J. I. Maletic and M. L. Collard, “Supporting source code difference analysis,” in Proceedings of the 20th IEEE International Conference on Software Maintenance. (pp. 210-219), 2004.

6. Fei, Zhiwei et al. “LawBench: Benchmarking Legal Knowledge of Large Language Models.” arXiv, Sep. 28, 2023. http://arxiv.org/abs/2309.16289.

7. Wehnert, Sabine, Shipra Dureja, Libin Kutty, Viju Sudhi, and Ernesto William De Luca. “Applying BERT Embeddings to Predict Legal Textual Entailment.” The Review of Socionetwork Strategies 16, no. 1 (April 2022): 197-219. https://doi.org/10.1007/s12626-022-00101-3. The authors use LLMs in combination with graph data structures.

We claim:

1. A method for data provenance management for use with artificial intelligence comprising:
sending, by a user interface, a prompt and a set of command parameters to a data provenance module;
receiving, by the data provenance module, the prompt and command parameters;
transmitting, by the data provenance module, the prompt and a set of AI command parameters to an AI module;
receiving, by the AI module, the prompt and a set of AI command parameters;
generating, by the AI module, a response to the prompt and a set of metadata elements;
transmitting, by the AI module, the response and the set of metadata elements to the data provenance module;
receiving, by the data provenance module, the response and the set of metadata elements;
constructing, by the data provenance module, a data provenance record for the response; and
storing, by a storage module, the response and its corresponding data provenance record.

2. The method of claim 1, wherein a (possibly empty) set of analysis modules are integrated into the method by:
receiving, from the data provenance module, a set of analysis data that includes the response, the metadata elements, and other information (e.g., the prompt, the command the parameters, the AI command parameters);
performing, by an analysis model, additional analysis (e.g., risk estimation using public risk registers);
sending, from the analysis model to the data provenance module, a set of analysis data elements; and
integrating, by the data provenance module, the set of analysis data elements into the data provenance record.

3. The method of claim 2, wherein the user interface is a feature of a document editing application (e.g., Google Drive, Microsoft Word) that is being used by a user to create or modify a document (represented in the document editing application by a document data structure), and the user adds AI generated content into the document by:
entering, by the user, the prompt into the user interface;
receiving, from the data provenance module, the response and data provenance record;
updating, by the data provenance module, the document data structure to include the response (at the location in the document indicated by the user); and
updating, by the data provenance module, the document data structure to include a set of data provenance elements derived from the data provenance record (e.g., adding the response and the data provenance record to the “track changes” history or metadata portions of the data structures).

4. The method of claim 3, wherein the user interface provides feedback to the user by:
displaying to the user, by the user interface, a visualization of the document that shows information derived from the data provenance elements of the current document data structure.

5. The method of any of the preceding claims, further comprising the use of a security module to provide tamper-proofing and non-repudiation by:
receiving, from the data provenance module, the response, the metadata elements, and other information (e.g., the prompt, the command parameters, the AI command parameters, the set of analysis data elements);
creating, by the security module, a secure record using cryptographic techniques; and
storing, by the storage module or by the security module, the secure record.

6. The method of any of the preceding claims, wherein the data provenance module does not act as a mediator between the user interface and AI module, but the method achieves the same result by:
sending, by a user interface, a prompt and a set of command parameters to an AI assistant module that is configured to communicate with the AI module (e.g., through an API endpoint available via HTTP) and that is configured to send information to the data provenance module (e.g., through RPC or publish/subscribe);
receiving, by the AI assistant module, the prompt and command parameters;
transmitting, by the AI assistant module, the prompt and a set of AI command parameters to an AI module;
transmitting, by the AI assistant module, a set of query elements (e.g., the prompt, the command parameters, and a set of AI command parameters) to the data provenance module;
receiving, by the AI module, the prompt and a set of AI command parameters;
generating, by the AI module, a response to the prompt and a set of metadata elements;
transmitting, by the AI module, the response and the set of metadata elements to the AI assistant module;
receiving, by the AI assistant module, the response and the set of metadata elements;
transmitting, by the AI assistant module, the response and the set of metadata elements to the data provenance module; and
constructing, by the data provenance module, a data provenance record for the response.
